(19) United States
(12) Patent Application Publication
(10) Pub. No.: US 2013/0157028 A1
(43) Pub. Date: Jun. 20, 2013

(54) MAT OF POLYMER FIBERS CONTAINING AN ACETOACETAMIDE AND USE THEREOF

(71) Applicants: Benjamin Blanchard, Taverny (FR); Boris Jaffrennou, Paris (FR); Katarzyna Chuda, Asnieres Sur Seine (FR)

(72) Inventors: Benjamin Blanchard, Taverny (FR); Boris Jaffrennou, Paris (FR); Katarzyna Chuda, Asnieres Sur Seine (FR)

(73) Assignee: SAINT-GOBAIN ADFORS, Chambery (FR)

(21) Appl. No.: 13/699,931

(22) PCT Filed: May 13, 2011
(86) PCT No.: PCT/FR11/51073

§ 371 Date: Feb. 7, 2013

(30) Foreign Application Priority Data
May 25, 2010 (FR) 1054020

(51) Int. Cl. B32B 27/34

(52) U.S. Cl. CPC B32B 27/34
USPC 428/219; 442/327

(57) ABSTRACT

The present invention relates to a mat of polymer fibers capable of trapping formaldehyde which contains at least 0.5% by weight of an acetoacetamide of formula:

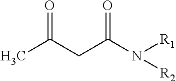

in which R₁ and R₂, which may be identical or different, represent a hydrogen atom, a methyl radical or an ethyl radical.

Another subject of the invention is the use of said mat, in particular as a surface covering for thermal and/or sound insulation products, in particular based on mineral wool, polystyrene or on an organic or inorganic foam.

The invention relates to a mat of polymer fibers which contains an acetoacetamide as an agent capable of trapping formaldehyde.

Highly varied composite materials are used in the field of the construction and fitting out of dwellings and offices, and also of transportation vehicles. Some of these materials, such as sound and/or thermal insulators, wooden panels, furniture parts and decorative parts, use adhesives, paints and varnishes comprising formaldehyde-based resins. The proportion of free formaldehyde in these materials is kept at a very low level owing to the incorporation of a small amount of agents capable of trapping formaldehyde (see EP-A-1 510 607 and CA-A-2034217).

However, regulations regarding protection against undesirable emissions of products, such as formaldehyde, which may exhibit a risk to the health of the individual are becoming stricter and require a further reduction in the amount of free formaldehyde present in materials or capable of being emitted by materials over time.

Means for reducing the content of formaldehyde inside buildings are known.

The proposal has been made to include particles of photocatalytic titanium oxide in a paint or material made of plaster (US-A-2005/0226761), a paper or a textile, plastic or wooden material (EP-A-1 437 397).

It is also known to use a hydrazide in a construction material based on plaster or on cement (US-A-2004/0101695 and JP-A-2004115340).

It is also known to use a carbodihydrazide in a fiberboard in order to capture and decompose formaldehyde and acetaldehyde (EP 1 905 560).

The aim of the present invention is to reduce the amount of formaldehyde present inside buildings, in particular dwellings, and transportation vehicles.

To achieve this aim, the present invention provides a mat of polymer fibers which contains at least 0.5% by weight of an acetoacetamide of formula:

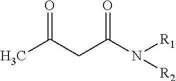

in which R₁ and R₂, which may be identical or different, represent a hydrogen atom, a methyl radical or an ethyl radical.

Another subject of the invention relates to the use of the aforementioned mat, in particular as a surface covering for thermal and/or sound insulation products based on mineral wool.

The acetoacetamide in accordance with the present invention is an organic compound which bonds to formaldehyde via a covalent bond. The acetoacetamide is capable of trapping the formaldehyde present in the ambient air and also the free formaldehyde possibly contained in materials used for the construction of dwellings.

Preferably, the amount of acetoacetamide represents 0.6 to 20%, advantageously 1.5 to 10% and better still is at least equal to 3% of the weight of the mat of polymer fibers.

Advantageously, the acetoacetamide is used together with a surfactant, the purpose of which is to increase the affinity of the fibers for the acetoacetamide. This results in a more homogeneous distribution of the acetoacetamide in the mat.

The surfactant in accordance with the invention may be an anionic, cationic or nonionic surfactant. Anionic surfactants are preferred and among these alkyl diphenyl oxide disulfonate.

The amount of surfactant generally represents less than 90%, preferably from 5 to 50%, and advantageously from 20 to 30% of the weight of the acetoacetamide.

The mat in accordance with the invention is based on fibers preferably constituted of an organic polymer.

As examples, mention may be made of fibers of polyolefin, for example of polyethylene, of polypropylene, of polyisobutylene and of polymethylpentene, of polyvinyl acetate (homopolymer or copolymer), for example of ethylene/vinyl acetate (EVA), of polyvinyl alcohol (homopolymer or copolymer), for example of ethylene/vinyl alcohol, of polylactic acid, of acrylonitrile, for example modacrylic (containing 35 to 85% of acrylonitrile units), of polyoxyalkylene, for example of polyoxyethylene, of polyoxyphenylene, of polyacrylic or of polyacrylate, for example of polymethyl methacrylate (PMMA), of polyester, especially of polyalkylene terephthalate, for example of polyethylene terephthalate and polybutylene terephthalate, of polyamide, of polyimide, of chlorinated and/or fluorinated polymer, for example of polyvinyl chloride, of polychlorofluoroethylene, of perfluoroethylene and of perfluoropropylene, of polysulfone, for example polyethersulfone, of polyurethane, especially elastane (at least 85% of thermoplastic polyurethane elastomer), of polybenzimidazole and of aramid.

The preferred fibers are fibers of a thermoplastic polymer since they can be obtained easily by conventional processes that take place by spinning or cospinning of molten plastic, in particular of polyester, advantageously of polyethylene terephthalate.

The mat may be constituted of fibers constituted of a single polymer or of a mixture of fibers of different polymers.

The mat of polymer fibers may be composed of continuous filaments, or of discontinuous filaments having a length which may reach 1000 mm, preferably that varies from 5 to 500 mm and advantageously from 50 to 100 mm.

The linear density of the fibers may vary to a large extent, for example up to 30 dtex, preferably is at least equal to 0.9 dtex, advantageously varies from 2 to 20 dtex and better still from 3 to 10 dtex.

Although the invention relates more particularly to a mat of fibers of synthetic polymer, it also applies to fibers of a polymer of natural origin containing, in particular, polysaccharides and/or proteins, such as animal fibers (wool or silk) and plant fibers (cotton, flax, hemp, sisal, coir, bamboo, etc.).

The mat in accordance with the invention may be constituted of the aforementioned synthetic or natural fibers or of a mixture of these fibers.

The mat of polymer fibers may also comprise reinforcing elements in the form of fibers having a diameter greater than the diameter of the polymer fibers that constitute the mat, or of strands composed of a plurality of filaments, that have or have not undergone twisting. The reinforcing elements may be constituted of a polymer material identical to or different from that of the fibers constituting the mat, or of another material, for example of glass.

The proportion of the reinforcing elements in the mat of polymer fibers remains low and generally represents at most 10% of the weight of the polymer fibers.

The mat of polymer fibers in accordance with the present invention has a surface density that varies from 5 to 1000 g/m², preferably from 10 to 800 g/m², advantageously from 15 to 300 g/m² and better still is at most equal to 100 g/m².

Of course, higher surface densities may be obtained by superposing several mats of polymer fibers in accordance with the present invention.

The mat that can be used within the context of the present invention may be manufactured according to known processes, in particular by dry processes that take place by carding or by aerodynamic defibering (airlaid processes), by molten processes that take place by direct spinning (spunlaid processes) or by extrusion (spun bonding or melt blowing processes), by wet processes that take place starting from a suspension of fibers in water, similar to that used for obtaining paper or by specific techniques, for example electrospinning and flash spinning.

Conventionally, the mat of polymer fibers may also contain a binder which binds said fibers and confers thereon mechanical properties suitable for the desired use, especially a sufficient stiffness in order to be able to be handled easily.

The binder generally comprises at least one polymer capable of binding the fibers, said polymer possibly being of the same nature or of a different nature from that constituting the fibers.

This polymer may be a thermoplastic polymer, for example styrene/acrylonitrile, acrylonitrile/butadiene/styrene, cellulose (tri)acetate, expanded polystyrene, a polyolefin such as polyethylene and polypropylene, a poly(meth)acrylate, a polyvinyl acetate or a polyoxymethylene; a thermosetting polymer, for example an unsaturated polyester, an epoxide, a phenolic resin such as a novolac or a resol, in particular having a content of free aldehyde(s) of less than 0.05%, a polyimide, a polyurethane, a phenoplast or a biopolymer, for example a polysaccharide or a protein; an elastomeric polymer, for example a fluoropolymer, in particular based on vinylidene fluoride, neoprene, a polyacrylic, a polybutadiene, a polyether amide, a silicone, a natural rubber or styrene-butadiene rubber (SBR), or a biopolymer, for example a polysaccharide or a protein.

The binder generally represents 5 to 300%, preferably less than 100%, by weight of the mat of polymer fibers.

In this case, it is necessary to treat the mat of polymer fibers at a sufficient temperature so that the binder can crosslink. The treatment temperature depends on the polymer constituting the fibers of the mat and on the polymer incorporated into the composition of the binder: it must remain well below the decomposition temperature of the polymer of the fibers in order to prevent the destruction of the mat.

The application of the acetoacetamide to the mat of polymer fibers may be carried out by any known means, for example by impregnation, coating or spraying a solution, dispersion or an emulsion of said acetoacetamide.

The liquid phase that can be used for dissolving, dispersing or emulsifying the acetoacetamide is generally water.

The liquid phase may also comprise a small proportion of a water-miscible co-solvent that increases the wettability of the polymer fibers.

The co-solvent is chosen from polar organic solvents such as alcohols, in particular ethanol or propanol, and ketones, in particular acetone.

As a general rule, the amount of co-solvent does not exceed 30% of the total weight of water and co-solvent, and preferably remains less than 20%.

The mat of polymer fibers in accordance with the present invention may be used in many applications, for example:
in construction, as a covering for walls, floors and/or ceilings, surface or sealing covering for gypsum board or cement board, or surface covering for thermal and/or sound insulation products, in particular based on mineral wool, polystyrene or an organic or inorganic foam, intended in particular for roof-boarding applications,
in motor vehicles, as trim material or decorative fabric (shelf, trunk, door, seat, floor carpet) or sound damping material (hood, floor pan, roof lining),
in the geological field, as geotextiles, in particular covering for asphalt or soil stabilization material,
in industry, as coated fabric, filter for gases (ventilation, air conditioning) or liquids such as oils, covering for the protection of seeds and cultures or covering for furnishings (wallpaper base or carpet underlay).

The following example makes it possible to illustrate the invention without however limiting it.

### EXAMPLE

a) Obtaining the Mat

Into a container, 135.25 g of water, 11.75 g of acetoacetamide (R₁=R₂=H) and 3 g of alkyl diphenyl oxide disulfonate (Dowfax® sold by Dow Chemical) are poured.

A mat of polyethylene terephthalate fibers (18 g/m²) is immersed in the solution obtained, then it is withdrawn and dried in an oven at 110° C. for 1 minute.

The amount of acetoacetamide deposited on the mat is equal to 1 g/m².

b) Capacity to Trap Formaldehyde Under Static Conditions

The mat (25 cm×5 cm) is placed in a container containing a 0.4 g/l aqueous solution of formol. The mat is placed above the solution so that it is not in contact with it. The container is hermetically sealed, then it is placed in an oven at 50° C. for 16 hours.

The mat is withdrawn and washed with water in order to remove the formaldehyde that has not reacted with the acetoacetamide.

The mat is then cut into several pieces which are placed in a container containing 100 ml of distilled water, under stirring. The container is heated at 60° C. for 24 hours. The aqueous phase is recovered, it is filtered and the amount of formaldehyde that it contains is measured by spectrocolorimetry.

The capacity of the mat from the example according to the invention to trap formaldehyde is equal to 66.84 mg/m².

By comparison, an identical mat containing no acetoacetamide, treated under the same conditions, is not capable of trapping formaldehyde.

c) Capacity to Trap Formaldehyde Under Dynamic Conditions

A sample of the mat obtained under a) is placed in a device in accordance with the ISO 16000-9 standard, modified in that the specific ventilation flow rate is equal to 0.5 m³/(m²·h) and the load factor is equal to 1 m²/m³.

1—firstly, the test chamber of the device is fed with a continuous stream of air containing 95 μg/m³ of formaldehyde over 8 days. The amount of formaldehyde in the air entering and exiting is measured over a period of 8 days, and the reduction in the amount of formaldehyde per unit volume of air is calculated.

The formaldehyde is measured by liquid chromatography (HPLC) under the conditions of the ISO 16000-3 standard.

In Table 1, the reduction in the amount of formaldehyde carried out with the mat containing acetoacetamide is indicated in comparison with a mat that contains no agent capable of trapping the formaldehyde (Reference).

TABLE 1

| Reduction of formaldehyde | | |
|---|---|---|
| (μg/m³) | Example | Reference |
| 1 day | 10 | 0 |
| 2 days | 11 | 0 |
| 4 days | 17 | 0 |
| 8 days | 13 | 0 |

2—secondly, the chamber is supplied with air that contains no formaldehyde for 7 days and the amount of formaldehyde present in the air exiting the chamber is measured.

The formaldehyde is measured under the same conditions as in paragraph 1.

The amount of formaldehyde emitted by the mat according to the example in accordance with the invention is equivalent to that which is measured when the chamber does not contain any mat. It can be concluded therefrom that the formaldehyde is bonded to the acetoacetamide in a strong and lasting manner.

1. A mat of polymer fibers, comprising at least 0.5% by weight of an acetoacetamide of formula (I): 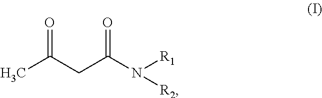
wherein R₁ and R₂ are each independently a hydrogen atom, a methyl radical, or an ethyl radical.

2. The mat of claim 1, wherein the amount of the acetoacetamide is from 0.6 to 20% of the weight of the mat.

3. The mat 2 of claim 1, further comprising an anionic, cationic, or nonionic surfactant.

4. The mat of claim 3, wherein the surfactant represents less than 90% of the weight of the acetoacetamide.

5. The mat of claim 1, wherein the polymer fibers comprise an organic polymer.

6. The mat of claim 5, wherein the organic polymer is a polyolefin, a polyvinyl acetate, a polyvinyl alcohol, a polylactic acid, an acrylonitrile, a polyoxyalkylene, a polyoxyphenylene, a polyacrylic, a polyacrylate, a polyester, a polyamide, a polyimide, a chlorinated and/or fluorinated polymer, a polysulfone, a polyurethane, a polybenzimidazole, or an aramid.

7. The mat of claim 6, wherein the organic polymer is a polyester.

8. The mat of claim 1, having a surface density from 5 to 1000 g/m².

9. The mat of claim 1, further comprising a binder comprising a polymer capable of binding the fibers, of the same nature or of a different nature to that which constitutes the fibers.

10. The mat of claim 9, wherein the polymer of the binder is a thermoplastic, thermosetting, or elastomeric polymer, or a biopolymer.

11. The mat of claim 9, wherein the binder represents 5 to 300% by weight of the mat of polymer fibers.

12. A covering comprising the mat of claim 1, wherein the covering is a wall covering, a floor covering, a ceiling covering, or any combination thereof.

13. A gypsum or cement board comprising a surface or sealing covering comprising the mat of claim 1.

14. A thermal and/or sound insulation product comprising a as surface covering comprising the mat of claim 1.

15. The mat of claim 1, wherein the amount of the acetoacetamide is from 1.5 to 10% of the weight of the mat.

16. The mat of claim 1, wherein the amount of the acetoacetamide is from 3 to 10% of the weight of the mat.

17. The mat of claim 3, wherein the surfactant represents from 5 to 50% of the weight of the acetoacetamide.

18. The mat of claim 3, wherein the surfactant represents from 20 to 30% of the weight of the acetoacetamide.

19. The mat of claim 1, having a surface density from 10 to 800 g/m².

20. The mat of claim 1, having a surface density from 15 to 100 g/m².
